(19) United States
(12) Patent Application Publication
(10) Pub. No.: US 2026/0340045 A1
(43) Pub. Date: Oct. 29, 2026

(54) INFORMATION PROCESSING APPARATUS, INFORMATION PROCESSING METHOD, AND NON-TRANSITORY RECORDING MEDIUM

(71) Applicant: NEC Corporation, Minato-ku, Tokyo (JP)

(72) Inventors: Akinori EBIHARA, Tokyo (JP); Taiki MIYAGAWA, Tokyo (JP)

(73) Assignee: NEC Corporation, Minato-ku, Tokyo (JP)

(21) Appl. No.: 19/113,012

(22) PCT Filed: Oct. 13, 2022
(86) PCT No.: PCT/JP2022/038259

§ 371 Date: Mar. 19, 2025

(51) Int. Cl. G06F 16/906

(52) U.S. Cl. CPC G06F 16/906

(57) ABSTRACT

An information processing apparatus includes: an acquisition unit that acquires a plurality of elements included in series data; a calculation unit that calculates a likelihood ratio indicating likelihood of a class to which the series data belong, by simultaneously inputting the plurality of elements and calculating a relation between the plurality of elements; and a classification unit that classifies the series data into at least one class of a plurality of classes serving as classification candidates, based on the likelihood ratio. According to such an information processing apparatus, it is possible to properly reflect the relation between the elements simultaneously inputted and to calculate an accurate likelihood ratio.

### TECHNICAL FIELD

The present disclosure relates to technical fields of an information processing apparatus, an information processing method, and a recording medium.

### BACKGROUND ART

A known apparatus of this type performs class classification of series data by using a likelihood ratio. For example, Patent Literature 1 discloses that the series data are classified into any one of a plurality of predetermined classes by sequentially acquiring and analyzing a plurality of elements included in the series data.

As another related technique/technology, for example, Patent Literature 2 discloses that a combination vector is used to perform time-series integration and to extract a feature vector. Patent Literature 3 discloses that an estimation method that minimizes a KL length, i.e., KLIEP (Kullback Leibler Importance Estimation Procedure), is used to estimate a log-likelihood ratio.

### CITATION LIST

### Patent Literature

Patent Literature 1: International Publication No. WO 2020/194497
Patent Literature 2: International Publication No. WO 2022/144992
Patent Literature 3: International Publication No. WO 2021/229663

### SUMMARY

### Technical Problem

The present disclosure aims to improve the techniques/technologies disclosed in Citation List.

### Solution to Problem

An information processing apparatus according to an example aspect of the present disclosure includes: an acquisition unit that acquires a plurality of elements included in series data; a calculation unit that calculates a likelihood ratio indicating likelihood of a class to which the series data belong, by simultaneously inputting the plurality of elements and calculating a relation between the plurality of elements; and a classification unit that classifies the series data into at least one class of a plurality of classes serving as classification candidates, based on the likelihood ratio. According to such an information processing apparatus, it is possible to properly reflect the relation between the elements simultaneously inputted and to calculate an accurate likelihood ratio.

An information processing method according to an example aspect of the present disclosure includes: acquiring a plurality of elements included in series data; calculating a likelihood ratio indicating likelihood of a class to which the series data belong, by simultaneously inputting the plurality of elements and calculating a relation between the plurality of elements; and classifying the series data into at least one class of a plurality of classes serving as classification candidates, based on the likelihood ratio.

A recording medium according to an example aspect of the present disclosure is a recording medium on which a computer program that allows at least one computer to execute an information processing method is recorded, the information processing method including: acquiring a plurality of elements included in series data; calculating a likelihood ratio indicating likelihood of a class to which the series data belong, by simultaneously inputting the plurality of elements and calculating a relation between the plurality of elements; and classifying the series data into at least one class of a plurality of classes serving as classification candidates, based on the likelihood ratio.

### BRIEF DESCRIPTION OF DRAWINGS

FIG. 1 is a block diagram illustrating a hardware configuration of an information processing apparatus according to a first example embodiment.

FIG. 2 is a block diagram illustrating a functional configuration of the information processing apparatus according to the first example embodiment.

FIG. 3 is a flowchart illustrating a flow of operation of the information processing apparatus according to the first example embodiment.

FIG. 4 is a graph illustrating, with a comparative example, an example of a likelihood ratio calculated by the information processing apparatus according to the first example embodiment.

FIG. 5 is a conceptual diagram illustrating an example of inconsecutive elements simultaneously inputted by an information processing apparatus according to a second example embodiment.

FIG. 6 is a block diagram illustrating a configuration of a self-attention mechanism used in an information processing apparatus according to a third example embodiment.

FIG. 7 is a conceptual diagram illustrating a method of calculating a likelihood ratio in the information processing apparatus according to the third example embodiment.

FIG. 8 is a conceptual diagram illustrating a method of calculating the likelihood ratio in an information processing apparatus according to a comparative example.

FIG. 9 is a conceptual diagram illustrating output integration by an information processing apparatus according to a fourth example embodiment.

### DESCRIPTION OF EXAMPLE EMBODIMENTS

Hereinafter, an information processing apparatus, an information processing method, and a recording medium according to example embodiments will be described with reference to the drawings.

### First Example Embodiment

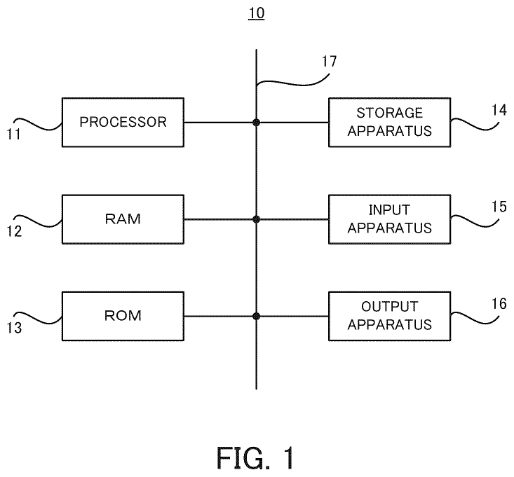

An information processing apparatus according to a first example embodiment will be described with reference to FIG. 1 to FIG. 4.

### Hardware Configuration

First, with reference to FIG. 1, a hardware configuration of the information processing apparatus according to the first example embodiment will be described. FIG. 1 is a block diagram illustrating the hardware configuration of the information processing apparatus according to the first example embodiment.

As illustrated in FIG. 1, an information processing apparatus 10 according to the first example embodiment includes a processor 11, a RAM (Random Access Memory) 12, a ROM (Read Only Memory) 13, and a storage apparatus 14. The information processing apparatus 10 may further include an input apparatus 15 and an output apparatus 16. The processor 11, the RAM 12, the ROM 13, the storage apparatus 14, the input apparatus 15, and the output apparatus 16 are each connected via a data bus 17.

The processor 11 reads a computer program. For example, the processor 11 is configured to read a computer program stored by at least one of the RAM 12, the ROM 13, and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing apparatus 10 via a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for performing class classification based on a likelihood ratio is realized in the processor 11. That is, the processor 11 may function as a controller for executing each control in the information processing apparatus 10.

The processor 11 may be configured as, for example, a CPU (Central Processing Unit), a GPU (Graphics Processing Unit), a FPGA (field-programmable gate array), a DSP (Demand-Side Platform), an ASIC (Application Specific Integrated Circuit), or a quantum processor. The processor 11 may be one of them, or may use a plurality of them in parallel.

The RAM 12 temporarily stores the computer program to be executed by the processor 11. The RAM 12 temporarily stores data that are temporarily used by the processor 11 when the processor 11 executes the computer program. The RAM 12 may be, for example, a D-RAM (Dynamic Random Access Memory) or a SRAM (Static Random Access Memory). Furthermore, another type of volatile memory may also be used in place of the RAM 12.

The ROM 13 stores the computer program to be executed by the processor 11. The ROM 13 may also store fixed data. The ROM 13 may be, for example, a P-ROM (Programmable Read Only Memory) or an EPROM (Erasable Read Only Memory). Furthermore, another type of non-volatile memory may also be used in place of the ROM13.

The storage apparatus 14 stores data that are stored by the information processing apparatus 10 for a long time. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing apparatus 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing apparatus 10 to the outside. For example, the output apparatus 16 may be a display apparatus (e.g., a display) that is configured to display the information about the information processing apparatus 10. The output apparatus 16 may be a speaker or the like that is configured to audio-output the information about the information processing apparatus 10. The output apparatus 16 may be configured as a portable terminal such as a smartphone and a tablet. The output apparatus 16 may be an apparatus that outputs information in a format other than an image. For example, the output apparatus 16 may be a speaker that audio-outputs the information about the information processing apparatus 10.

Although FIG. 1 illustrates the information processing apparatus 10 including a plurality of apparatuses, all or a part of the functions may be realized in a single apparatus. Such an information processing apparatus may include, for example, only the processor 11, the RAM 12, and the ROM 13. The other components (i.e., the storage apparatus 14, the input apparatus 15, the output apparatus 16, and the like) may be provided in an external apparatus connected to the information processing apparatus 10. In addition, in the information processing apparatus 10, a part of an arithmetic function may be realized by an external apparatus (e.g., an external server or cloud, etc.).

### Functional Configuration

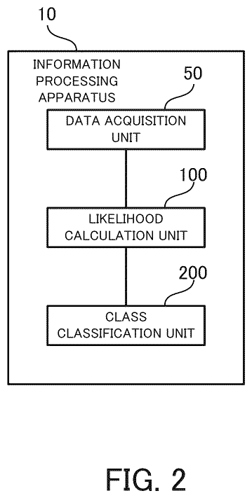

Next, with reference to FIG. 2, a functional configuration of the information processing apparatus 10 according to the first example embodiment will be described. FIG. 2 is a block diagram illustrating the functional configuration of the information processing apparatus according to the first example embodiment.

As illustrated in FIG. 2, the information processing apparatus 10 according to the first example embodiment is an apparatus that performs class classification of series data to be inputted, and includes, as components for realizing the functions thereof, a data acquisition unit 50, a likelihood ratio calculation unit 100, and a class classification unit 200. Each of the acquisition unit 50, the likelihood ratio calculation unit 100, and the class classification unit 200 may be a processing block realized by the processor 11 (see FIG. 1), for example.

The data acquisition unit 50 is configured to acquire a plurality of elements included in the series data. The data acquisition unit 50 may acquire data directly from an arbitrary data acquisition apparatus (e.g., a camera, a microphone, etc.), or may read data that are acquired in advance by a data acquisition apparatus and that are stored in a storage or the like. When acquiring data from a camera, the data acquisition unit 50 may be configured to acquire the data from each of a plurality of cameras. The elements of the series data acquired by the data acquisition unit 50 are configured to be outputted to the likelihood ratio calculation unit 100. The series data are data including a plurality of elements arranged in a predetermined order, and an example thereof may be time series data, for example. A more specific example of the series data includes, but is not limited to, a subdivision of video data, audio data, or image data.

The likelihood ratio calculation unit 100 is configured to calculate a likelihood ratio, based on the plurality of elements acquired by the data acquisition unit 50. The “likelihood ratio” here is an index indicating likelihood of a class to which the series data belong. The likelihood ratio calculation unit 100 calculates the likelihood ratio by calculating a relation between the plurality of elements. Furthermore, in particular, the likelihood ratio calculation unit 100 according to the present example embodiment is configured to calculate the likelihood ratio by simultaneously inputting a plurality of elements and calculating the relation between the elements. In a case where the elements are sequentially acquired by the acquisition unit 50, the likelihood ratio calculation unit 100 may calculate the likelihood ratio by simultaneously inputting all the elements acquired up to a present time, for example. A specific calculation method when the plurality of elements are simultaneously inputted, will be described in detail in another example embodiment later.

The class classification unit 200 is configured to classify the series data, based on the likelihood ratio calculated by the likelihood ratio calculation unit 100. The class classification unit 200 selects at least one class to which the series data belong, from among a plurality of classes serving as classification candidates. The plurality of classes serving as classification candidates may be set in advance. Alternatively, the plurality of classes serving as classification candidates may be suitably set by a user, or may be suitably set based on a type of the series data to be handled. For example, the plurality of classes may be set as a class indicating that a face included in video data is a legitimate/real face (i.e., a face of a living body) and a class indicating that the face is a false face (e.g., a photograph or a face of a 3D mask). In this way, the information processing apparatus is usable spoofing/impersonation detection apparatus. Note that the number of the plurality of classes serving as classification candidates is not limited to 2, and may be 3 or more.

The information processing apparatus 10 may be configured to include a not-illustrated learning unit. Specifically, the information processing apparatus 10 may be configured to have a function of performing learning about calculation of the likelihood ratio. The learning of the information processing apparatus 10 is performed by inputting training data prepared in advance, for example. The training data may be configured as a set of the series data and information about a correct answer class to which the series data belong (i.e., correct data), for example. In the learning of the information processing apparatus 10, each parameter of the information processing apparatus 10 may be optimized so as to reduce a loss function calculated by inputting the training data, for example.

### Flow of Operation

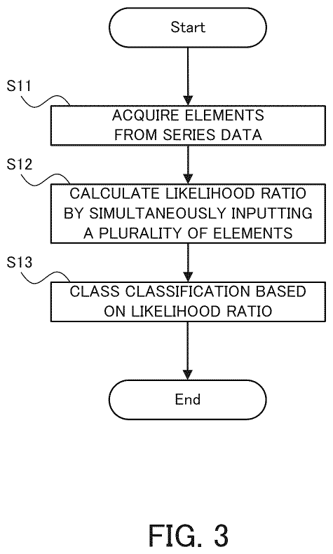

Next, a flow of operation of the information processing apparatus 10 according to the first example embodiment will be described with reference to FIG. 3. FIG. 3 is a flowchart illustrating the flow of the operation of the information processing apparatus according to the first example embodiment.

As illustrated in FIG. 3, when the operation of the information processing apparatus 10 is started, first, the data acquisition unit 50 acquires the elements included in the series data (step S11). The data acquisition unit 50 outputs the acquired element of the series data to the likelihood ratio calculation unit 100.

Subsequently, the likelihood ratio calculation unit 100 calculates the likelihood ratio by simultaneously inputting the plurality of elements acquired by the data acquisition unit 50 (step S12). For example, in a case where video data are acquired as the series data, the likelihood ratio calculation unit 100 may calculate the likelihood ratio by simultaneously inputting a plurality of frames in the video data. The plurality of elements are simultaneously inputted, by which the likelihood ratio is calculated in consideration of the relation between the plurality of elements. The likelihood ratio calculation unit 100 outputs the calculated likelihood ratio to the class classification unit 200.

Subsequently, the class classification unit 200 performs class classification based on the calculated likelihood ratio (step S13). The class classification may be intended to determine one class to which the series data belong, or to determine a plurality of classes to which the series data are likely to belong. The class classification unit 200 may have a function of outputting a result of the class classification. For example, the class classification unit 200 may output the result of the class classification onto a display or the like. Alternatively, the class classification unit 200 may audio-output the result of the class classification via a speaker or the like.

In a case where the calculated likelihood ratio does not exceed a predetermined threshold (i.e., a threshold for determining to which class the series data are classified), the class classification unit 200 may calculate the likelihood ratio again without performing the class classification (i.e., without determining the class to which the series data are classified). In this instance, the data acquisition unit 50 newly acquires the elements included in the series data, by which a new likelihood ratio may be calculated. For example, a new likelihood ratio may be calculated by simultaneously inputting all the elements acquired so far and the newly acquired elements.

### Technical Effect

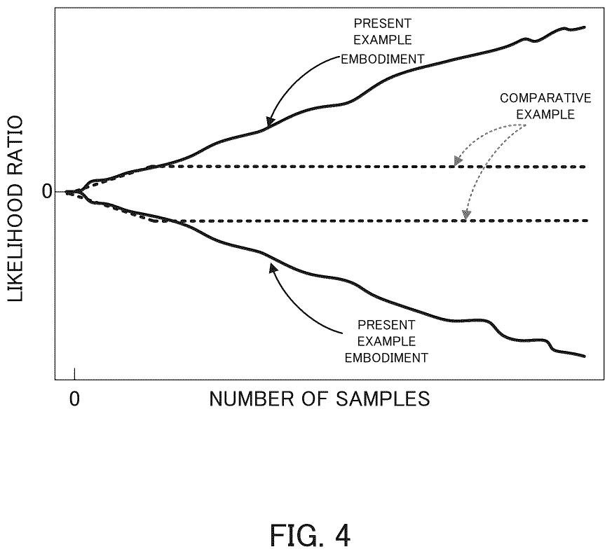

Next, with reference to FIG. 4, a technical effect obtained by the information processing apparatus 10 according to the first example embodiment will be described. FIG. 4 is a graph illustrating, with a comparative example, an example of the likelihood ratio calculated by the information processing apparatus according to the first example embodiment.

In FIG. 4, it is preferable that the likelihood ratio used for class classification gradually changes in one predetermined direction with increasing number of samples (i.e., elements to be inputted). In the comparative example in which a plurality of elements are not simultaneously inputted, however, the likelihood ratio peaks out or is flatten out (i.e., a change in the likelihood ratio is stopped) even when the number of samples increases. One of the reasons why the likelihood ratio peaks out is that the relation between the plurality of elements is not properly reflected, for example. Specifically, in the comparative example, since the acquired elements are sequentially inputted one by one, a relation between distant pieces of data is no longer considered, and as a consequence, the likelihood ratio is believed to peak out. Such a state in which the likelihood ratio peaks out does not occur in all cases, but if it does, there is a risk that appropriate class classification may not be possible.

In the information processing apparatus 10 according to the first example embodiment, however, the likelihood ratio is calculated by simultaneously inputting the plurality of elements and calculating the relation between the elements. In this way, it is possible to calculate the likelihood ratio that properly reflects the relation between the elements simultaneously inputted. Therefore, the information processing apparatus 10 according to the first example embodiment is allowed to calculate a more accurate likelihood ratio than that when the plurality of elements are not simultaneously inputted.

### Second Example Embodiment

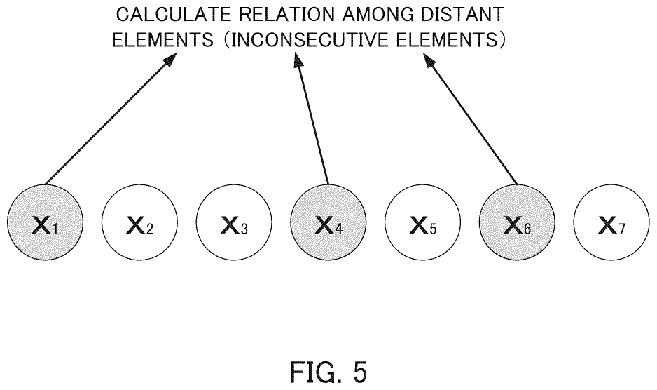

The information processing apparatus 10 according to a second example embodiment will be described with reference to FIG. 5. The second example embodiment partially differs from the first example embodiment only in the operation, and may be the same as the first example embodiment in the other parts. For this reason, a part differing from the first example embodiment will be described in detail below, and a description of the other overlapping parts will be omitted as appropriate.

### Input of Inconsecutive Elements

First, a plurality of elements used to calculate the likelihood ratio in the information processing apparatus 10 according to the second example embodiment will be described with reference to FIG. 5. FIG. 5 is a conceptual diagram illustrating an example of inconsecutive elements simultaneously inputted in the information processing apparatus according to the second example embodiment.

As illustrated in FIG. 5, in the information processing apparatus 10 according to the second example embodiment, the likelihood ratio is calculated by simultaneously inputting inconsecutive (i.e., elements distant from each other) out of the plurality of elements included in the series data. In the example illustrated in the drawings, out of elements x₁ to x₇ of the series data, x₁, x₄, and x₆ are simultaneously inputted into the likelihood ratio calculation unit 100. For example, in a case where video data are acquired as the series data, in the information processing apparatus 10 according to the second example embodiment, a plurality of inconsecutive frames on a time series (in other words, discrete frames obtained by omitting a frame(s) in between) are simultaneously inputted into the likelihood ratio calculation unit. Then, the likelihood ratio calculation unit 100 calculates the likelihood ratio from the plurality of consecutive frames inputted.

In the example illustrated in FIG. 5, all the elements to be inputted are inconsecutive, but inconsecutive elements and consecutive elements may be simultaneously inputted. That is, all the plurality of elements to be inputted are not necessarily inconsecutive, and if at least one of the plurality of elements to be inputted is inconsecutive, a technical effect described later is obtained accordingly. For example, out of the elements x₁ to x₇ illustrated in FIG. 5, x₁, x₂, and x₃ (consecutive elements), and x₅ (an inconsecutive element) may be simultaneously inputted.

### Technical Effect

Next, a technical effect obtained by the information processing apparatus 10 according to the second example embodiment will be described.

As described in FIG. 5, in the information processing apparatus 10 according to the second example embodiment, the likelihood ratio is calculated by simultaneously inputting the inconsecutive elements (i.e., the elements distant from each other on the series data). In this way, it is possible to calculate the likelihood ratio in consideration the relation between the elements distant from each other. Therefore, it is possible to calculate a more accurate likelihood ratio than that when only the consecutive elements are simultaneously inputted (i.e., when only the relation between the consecutive elements is considered).

### Third Example Embodiment

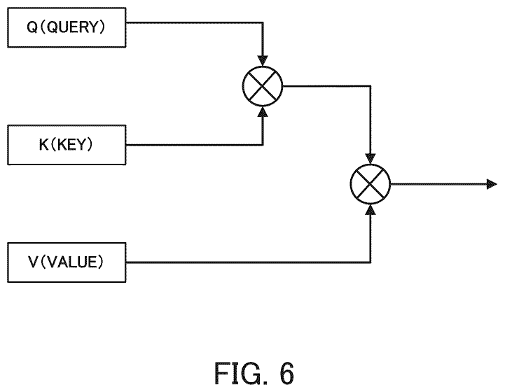

The information processing apparatus 10 according to a third example embodiment will be described with reference to FIG. 6 to FIG. 8. The third example embodiment partially differs from the first and second example embodiments only in the operation, and may be the same as the first and second example embodiments in the other parts. For this reason, a part differing from each of the example embodiments described above will be described in detail below, and a description of the other overlapping parts will be omitted as appropriate.

### Self-Attention Mechanism

First, a self-attention mechanism used in the information processing apparatus 10 according to the third example embodiment will be described with reference to FIG. 6. FIG. 6 is a block diagram illustrating a configuration of the self-attention mechanism used in the information processing apparatus according to the third example embodiment.

In FIG. 6, in the information processing apparatus 10 according to the third example embodiment, the likelihood ratio is calculated by using the self-attention mechanism. In the self-attention mechanism, Q (Query), K (Key), and V (Value), which are feature quantities, are used. These feature quantities may be extracted from each of the elements acquired from the series data.

The self-attention mechanism first calculates a matrix product of Q (Query) and K (Key). In this case, the self-attention mechanism may perform processing of normalizing the calculated matrix product. For example, the self-attention mechanism may perform the normalization processing using a Softmax-function.

Subsequently, the self-attention mechanism calculates a matrix product of V (Value) and the matrix product of Q (Query) and K (Key). The matrix product calculated here is an output of the self-attention mechanism. The self-attention mechanism may perform predetermined restoration processing or residual processing on the calculated matrix product.

### Calculation of Likelihood Ratio Using Self-Attention Mechanism

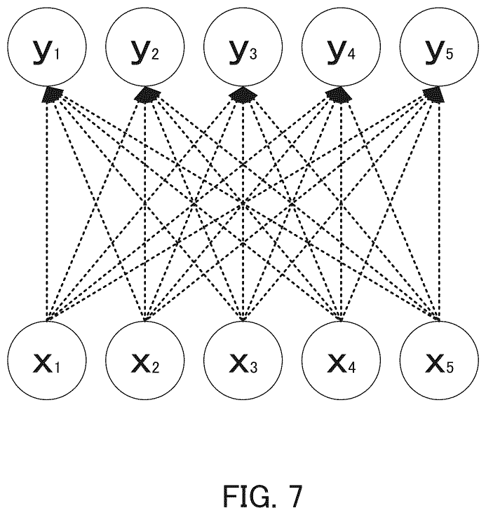

Next, calculation of the likelihood ratio using the self-attention mechanism described above will be described with reference to FIG. 7. FIG. 7 is a conceptual diagram illustrating a method of calculating the likelihood ratio in the information processing apparatus according to the third example embodiment.

As illustrated in FIG. 7, in the information processing apparatus 10 according to the third example embodiment, a plurality of elements are simultaneously inputted into the self-attention mechanism. Described here is an example in which elements x₁ to x₅ are inputted. In the self-attention mechanism, the relation between the elements are calculated, and outputs y₁ to y₅ are obtained as a consequence. Specifically, each of the outputs y₁ to y₅ is a value that takes into account the elements x₁ to x₅. The likelihood ratio calculation unit 100 is configured to calculate the likelihood ratio from these outputs y₁ to y₅. A method of calculating the likelihood ratio from the plurality of outputs will be described in another example embodiments later.

### Technical Effect

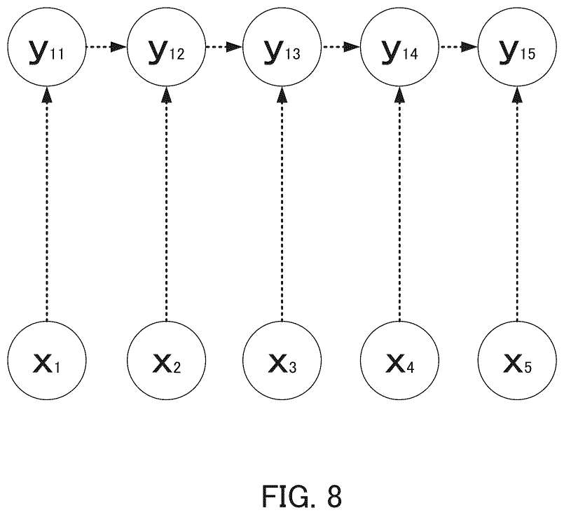

Next, a technical effect obtained by the information processing apparatus 10 according to the third example embodiment will be described with reference to FIG. 8. FIG. 8 is a conceptual diagram illustrating a method of calculating the likelihood ratio in an information processing apparatus according to a comparative example.

In FIG. 8, the information processing apparatus according to the comparative example is configured to calculate the likelihood ratio by sequentially inputting a plurality of elements one by one. Specifically, in the information processing apparatus according to the comparative example, when the element x₁ is inputted, y₁₁ is obtained as an output based on the element x₁. Thereafter, when the element x₂ is inputted, y₁₂ is obtained as an output based on the inputted element x₂ and based on the previous output y₁₁. As described above, in the information processing apparatus according to the comparative example, calculation based on the inputted element and the previous output(s) is repeated.

In the information processing apparatus according to the comparative example, however, since the elements are inputted one by one, there is a possibility that there is little influence/effect of the previous elements. For example, in the example illustrated in FIG. 8, it is considered that the influence/effect of the firstly inputted element x₁ in the last output y₁₅ is smaller than that of the element x₅ inputted immediately before. Such a situation may cause the likelihood ratio to peak out, as described in FIG. 4, for example.

In the information processing apparatus 10 according to the third example embodiment, however, the likelihood ratio is calculated by simultaneously inputting the plurality of elements in the self-attention mechanism. In this way, it is possible to calculate the likelihood ratio that properly reflects the relation between the elements simultaneously inputted. In other words, since all the elements are simultaneously calculated, it is possible to prevent that the influence/effect of the elements inputted in the past is reduced as in the comparative example of FIG. 8. Therefore, it is possible to calculate a more accurate likelihood ratio. The present example embodiment describes an example in which the self-attention mechanism is used; however, the same technical effect is obtained even when the same mechanism, such as a MLP-mixer, is used.

### Fourth Example Embodiment

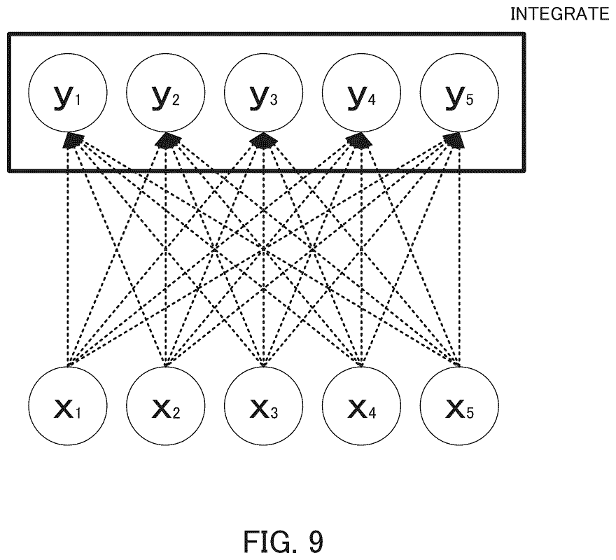

The information processing apparatus 10 according to a fourth example embodiment will be described with reference to FIG. 9. The fourth example embodiment describes a more specific operation example of the third example embodiment, and may be the same as the third example embodiment in the apparatus configuration and the operation as a whole. For this reason, a part differing from each of the example embodiments described above will be described in detail below, and a description of the other overlapping parts will be omitted as appropriate.

### Output Integration Processing

First, with reference to FIG. 9, output integration processing performed by the information processing apparatus 10 according to the fourth example embodiment (specifically, processing of integrating the outputs from the self-attention mechanism) will be described. FIG. 9 is a conceptual diagram illustrating the output integration by the information processing apparatus according to the fourth example embodiment.

As illustrated in FIG. 9, in the information processing apparatus 10 according to the fourth example embodiment, a plurality of elements are simultaneously inputted into the self-attention mechanism, and a plurality of corresponding outputs re obtained. That is, the same number of outputs as the number of inputted elements are obtained. That being said, it is hardly possible to use the plurality of outputs (vectors) as the likelihood ratio as it is. Therefore, the likelihood ratio calculation unit 100 according to the fourth example embodiment performs the output integration processing of integrating the plurality of outputs. It is therefore possible to calculate one likelihood ratio that takes into account all of the plurality of outputs.

The likelihood ratio calculation unit 100 integrates the plurality of outputs by using Normalized Sum Pooling (hereinafter referred to as “NSPooling” as appropriate), for example. Specifically, the likelihood ratio calculation unit 100 performs processing in which a sum of the plurality of outputs is divided by a maximum value of the plurality of outputs. That is, the likelihood ratio calculation unit 100 performs such processing as illustrated in Equation (1) below.

$$\begin{matrix}[ Equation 1 ] & \\ Y ← {\sum }_{t}^{T} {X}_{* t} / duration ( NSPooling ) & ( 1 )\end{matrix}$$

INPUT: X∈R^{d}feat^{×t}

OUTPUT: Y∈R^{d}feat^{×1}

A method used for the output integration processing is not limited to the above-described NSPooling. For example, the likelihood ratio calculation unit 100 may divide the sum of the plurality of outputs, by a predetermined constant. The likelihood ratio calculation unit 100 may also use a method of calculating an average of the plurality of outputs (Global Average Pooling). Alternatively, the likelihood ratio calculation unit 100 may use and select any one of the plurality of outputs.

### Technical Effect

Next, a technical effect obtained by the information processing apparatus 10 according to the fourth example embodiment will be described.

As described in FIG. 9, in the information processing apparatus 10 according to the fourth example embodiment, the likelihood ratio is calculated by integrating the plurality of outputs from the self-attention mechanism. In this way, it is possible to properly calculate the likelihood ratio in consideration of all the outputs from the self-attention mechanism. Furthermore, by using such a technique as NSPooling described above when integrating the plurality of outputs, it is possible to equalize contribution degrees of the plurality of elements.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of Saas (Software as a Service), for example.

### Supplementary Notes

The example embodiments described above may be further described as, but not limited to, the following Supplementary Notes below.

### Supplementary Note 1

An information processing apparatus according to Supplementary Note 1 is an information processing apparatus including: an acquisition unit that acquires a plurality of elements included in series data; a calculation unit that calculates a likelihood ratio indicating likelihood of a class to which the series data belong, by simultaneously inputting the plurality of elements and calculating a relation between the plurality of elements; and a classification unit that classifies the series data into at least one class of a plurality of classes serving as classification candidates, based on the likelihood ratio.

### Supplementary Note 2

An information processing apparatus according to Supplementary Note 2 is the information processing apparatus according to Supplementary Note 1, wherein the calculation unit simultaneously inputs inconsecutive elements in the series data and calculates a relation between the inconsecutive elements.

### Supplementary Note 3

An information processing apparatus according to Supplementary Note 3 is the information processing apparatus according to Supplementary Note 1 or 2, wherein the calculation unit calculates the likelihood ratio by using a self-attention mechanism.

### Supplementary Note 4

An information processing apparatus according to Supplementary Note 4 is the information processing apparatus according to Supplementary Note 3, wherein the calculation unit calculates the likelihood ratio by integrating a plurality of outputs from the self-attention mechanism.

### Supplementary Note 5

An information processing apparatus according to Supplementary Note 5 is the information processing apparatus according to Supplementary Note 4, wherein the calculation unit integrates the plurality of outputs by dividing a sum of the plurality of outputs, by a maximum value of the plurality of outputs.

### Supplementary Note 6

An information processing method according to Supplementary Note 6 is an information processing method that is executed by at least one computer, the information processing method including: acquiring a plurality of elements included in series data; calculating a likelihood ratio indicating likelihood of a class to which the series data belong, by simultaneously inputting the plurality of elements and calculating a relation between the plurality of elements; and classifying the series data into at least one class of a plurality of classes serving as classification candidates, based on the likelihood ratio.

### Supplementary Note 7

A recording medium according to Supplementary Note 7 is a recording medium on which a computer program that allows at least one computer to execute an information processing method is recorded, the information processing method including: acquiring a plurality of elements included in series data; calculating a likelihood ratio indicating likelihood of a class to which the series data belong, by simultaneously inputting the plurality of elements and calculating a relation between the plurality of elements; and classifying the series data into at least one class of a plurality of classes serving as classification candidates, based on the likelihood ratio.

### Supplementary Note 8

A computer program according to Supplementary Note 8 is a computer program that allows at least one computer to execute an information processing method, the information processing method including: acquiring a plurality of elements included in series data; calculating a likelihood ratio indicating likelihood of a class to which the series data belong, by simultaneously inputting the plurality of elements and calculating a relation between the plurality of elements; and classifying the series data into at least one class of a plurality of classes serving as classification candidates, based on the likelihood ratio.

### Supplementary Note 9

An information processing system according to Supplementary Note 1 is an information processing system including: an acquisition unit that acquires a plurality of elements included in series data; a calculation unit that calculates a likelihood ratio indicating likelihood of a class to which the series data belong, by simultaneously inputting the plurality of elements and calculating a relation between the plurality of elements; and a classification unit that classifies the series data into at least one class of a plurality of classes serving as classification candidates, based on the likelihood ratio.

The present disclosure is allowed to be changed, if desired, without departing from the essence or spirit of this disclosure which can be read from the claims and the entire specification. An information processing apparatus, an information processing method, and a recording medium with such changes are also intended to be within the technical scope of the present disclosure.

### DESCRIPTION OF REFERENCE CODES

10 Information processing apparatus
50 Data acquisition unit
100 Likelihood ratio calculation unit
200 Class classification unit

What is claimed is:

1. An information processing apparatus comprising:
at least one memory that is configured to store instructions; and
at least one processor that is configured to execute the instructions to:
acquire a plurality of elements included in series data;
calculate a likelihood ratio indicating likelihood of a class to which the series data belong, by simultaneously inputting the plurality of elements and calculating a relation between the plurality of elements; and
classify the series data into at least one class of a plurality of classes serving as classification candidates, based on the likelihood ratio.

2. The information processing apparatus according to claim 1, wherein the at least one processor is configured to execute the instructions to simultaneously input inconsecutive elements in the series data and calculate a relation between the inconsecutive elements.

3. The information processing apparatus according to claim 1, wherein the at least one processor is configured to execute the instructions to the calculate the likelihood ratio by using a self-attention mechanism.

4. The information processing apparatus according to claim 3, wherein the at least one processor is configured to execute the instructions to calculate the likelihood ratio by integrating a plurality of outputs from the self-attention mechanism.

5. The information processing apparatus according to claim 4, wherein the at least one processor is configured to execute the instructions to integrate the plurality of outputs by dividing a sum of the plurality of outputs, by a maximum value of the plurality of outputs.

6. An information processing method that is executed by at least one computer, the information processing method comprising:
acquiring a plurality of elements included in series data;
calculating a likelihood ratio indicating likelihood of a class to which the series data belong, by simultaneously inputting the plurality of elements and calculating a relation between the plurality of elements; and
classifying the series data into at least one class of a plurality of classes serving as classification candidates, based on the likelihood ratio.

7. A non-transitory_recording medium on which a computer program that allows at least one computer to execute an information processing method is recorded, the information processing method including:
acquiring a plurality of elements included in series data;
calculating a likelihood ratio indicating likelihood of a class to which the series data belong, by simultaneously inputting the plurality of elements and calculating a relation between the plurality of elements; and
classifying the series data into at least one class of a plurality of classes serving as classification candidates, based on the likelihood ratio.
